(19) United States
(12) Patent Application Publication
(10) Pub. No.: US 2023/0410067 A1
(43) Pub. Date: Dec. 21, 2023

(54) SYSTEMS AND METHODS FOR VIRTUAL CURRENCY EXCHANGE IN LIEU OF PHYSICAL CURRENCY EXCHANGE IN MERCHANT TRANSACTIONS

(71) Applicant: Pinch Financial Inc., Dover, DE (US)

(72) Inventor: Mark C. Attinger, Scottsdale, AZ (US)

(21) Appl. No.: 18/211,258

(22) Filed: Jun. 17, 2023

Related U.S. Application Data
(60) Provisional application No. 63/353,300, filed on Jun. 17, 2022.

(51) Int. Cl. G06Q 20/10; G06Q 20/38; G06Q 20/40

(52) U.S. Cl. CPC G06Q 20/10; G06Q 20/389; G06Q 20/401

(57) ABSTRACT

This invention is a software tool that helps manage and process transactions. It can take a request, match it with the right customer or seller, figure out the transaction fees, and update all relevant databases. Also, it will notify the parties involved. This tool makes handling financial transactions easier and more efficient.

### CROSS-REFERENCE TO RELATED APPLICATIONS

This application claims priority to U.S. Provisional Patent Application Ser. No. 63/353,300, filed Jun. 17, 2022 entitled “SYSTEMS AND METHODS FOR VIRTUAL CURRENCY EXCHANGE IN LIEU OF PHYSICAL CURRENCY EXCHANGE IN MERCHANT TRANSACTIONS” The entire content of that application is incorporated herein by reference.

### BACKGROUND

The use of coins in transaction processing has become more challenging in recent years for both customers and merchants. On the merchant side, it can be difficult to maintain an appropriate amount of coins on hand (e.g. in cash registers) in order to provide customers with proper change amounts in cash transactions. Moreover, it can be time consuming for a merchant to address obtaining coins needed for day to day operations. A merchant may need to plan the acquisition of coins, routinely track coin amounts present in-store, and place orders for coins so they are available when needed. In some scenarios, a merchant may be required to have an employee take time away from their typical in-store duties to go acquire coins when insufficient amounts are present in-store. This can lead to decreased productivity, diminished customer service, and potentially increased work hours which a merchant must pay in order to ensure all necessary tasks are accomplished. Merchant issues with coin management can be exacerbated by the ongoing national coin shortage. Furthermore, there is potential for coin change to be miscounted by merchant employees leading to accounting errors. The same or similar issues may also arise when change is owed in smaller bill increments (e.g. one dollar bills) as many customers may pay with larger bill values (e.g. twenty dollar bills) exceeding the transaction total. This may lead to a merchant repeatedly needing to provide smaller value bills in order to provide correct change which leads into the same problems discussed above of ensuring the necessary amount of small bill values on-hand/in-store for providing exact change to customers.

On the customer side, redeeming coins for cash or digital forms of currency can be limited and/or associated with significant service fees. For example, some banks no longer accept coins for deposit or in exchange for cash. Coin counting/collection machines may have limited locations and come with fees of several percent which can add up to significant costs to a user to simply exchange one form of money for another. Furthermore, customers may encounter scenarios where merchants require electronic payment or exact change if paying with physical currency which may not be convenient for the customer or may require the customer to overpay for a transaction due to merchants being unable to provide proper change to a customer.

### SUMMARY

The present invention overcomes these limitations by creating systems and methods for allocating virtual currency in lieu of physical currency in association with merchant transactions. In one aspect, the invention employs virtual currency terminals for use at merchant locations to allow merchants to pay coin change owed to a customer in a digital format (and in some cases accept virtual currency accumulated by a user as payment towards a transaction). This can significantly decrease the necessity for retailers to maintain coin supplies on-site and reduce the time, costs and productivity losses associated with coin management and upkeep. Furthermore, since the allocation of change is performed electronically, miscounting of coins and associated accounting issues can be reduced or eliminated. Moreover, users are not faced with requirements of having exact change, and provided with an alternative to handling physical coins and the associated challenges that come with coins as discussed above. The present invention maintains digital records of virtual currency accumulated (or owed) in lieu of physical coin exchange associated with cash purchase transactions and provides users with a variety of convenient ways to redeem their virtual currency accumulated in lieu of physical coins.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for managing virtual currency associated with physical currency transactions in accordance with an exemplary embodiment of the invention.

FIG. 2 illustrates a system for virtual currency processing in accordance with an exemplary embodiment of the present invention.

FIG. 3 illustrates an exemplary process for managing virtual currency in lieu of coin exchange in association with physical money transactions according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

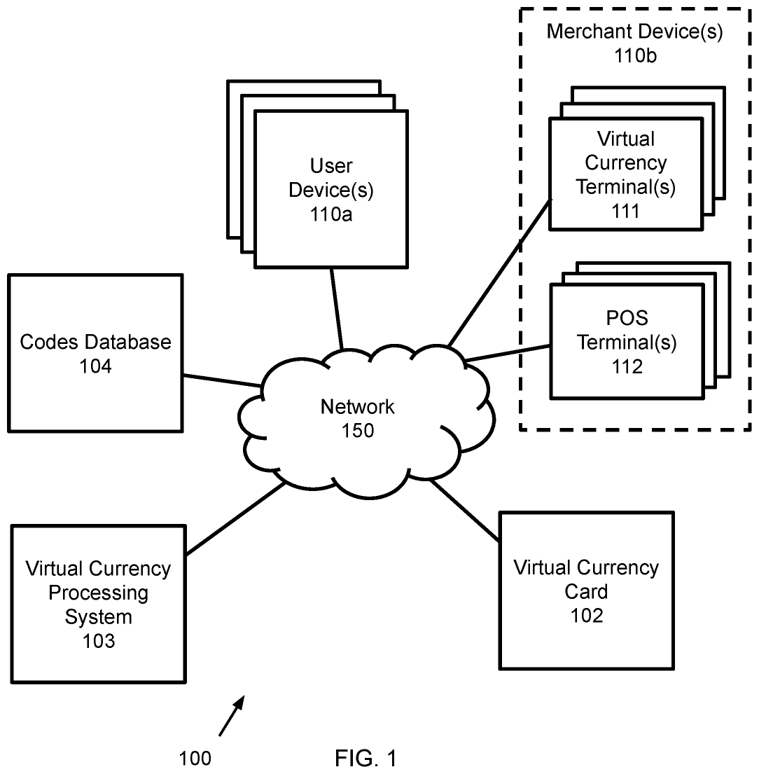

FIG. 1 illustrates an exemplary embodiment of a system 100 for managing virtual currency associated with physical currency transactions according to one embodiment. The system comprises user device(s) 110a, merchant device(s) 110b which may be comprised of at least one of a virtual currency terminal 111 and a point of sale (POS) terminal 112, a virtual currency processing system 103, codes database 104, optionally virtual currency card 102, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

As a general overview, merchant device(s) 110b are operable to process financial transactions such as in-store purchases. In circumstances where transactions are conducted using physical currency (e.g. cash, coin, etc.), the virtual currency terminal 111 and virtual currency processing system 103 may be relied upon to process the payment/exchange of change owed as opposed to reliance on physical coins. The virtual currency terminal 11 and processing system 103 are operable to conduct a virtual transfer of digital currency from one party to another in association with the transaction. In one aspect, the entire balance due as change may be converted into virtual currency to be granted to a customer/user. In one aspect, a portion of the entire balance due as change may be converted into virtual currency to be granted to a customer/user. In one aspect, only the portion of the balance due as change which would otherwise be paid in coin change may be converted into virtual currency to be granted to a customer/user. In this way, at least one of the customer and merchant are afforded flexible options for handling how change is paid in association with transactions without the need to always rely on physical money (coins and/or bills).

Merchant device(s) 110b, which may be comprised of at least one of point of sale (POS) terminal(s) 112 and virtual currency terminal(s) 111, are operable to process sales transactions. POS terminal(s) 112 may comprise any POS terminal and may be configured to interface with or otherwise interact with virtual currency terminal(s) 111. In one aspect, POS terminal(s) 112 may be configured to incorporate aspects of the virtual currency terminal(s) 111 such that a separate virtual currency terminal 111 is not needed. POS terminal(s) 112 are operable to process at least one form of payment from a customer. In one aspect, when processing a cash transaction, POS terminal may provide an option to invoke the virtual currency terminal(s) 111 to at least one of accept a virtual currency payment from a user (e.g. a customer) and allocate virtual currency to the user. In one aspect, POS terminal(s) 112 invokes the virtual currency terminal(s) 111 to allocate virtual currency to a user instead of providing physical coin change to the user in association with a physical cash transaction.

Virtual currency terminal(s) 111 are operable to obtain at least one of user information and transaction information. Virtual currency terminal(s) 111 may obtain transaction information such as the amount of change (in particular coin change) owed to a user. Virtual currency terminal(s) 111 may obtain user information including, but not limited to, user identification information, user virtual currency account information, etc. Virtual currency terminal(s) 111 may interface with virtual currency processing system 103 in order to at least one of obtain and provide at least one of the transaction information and user information. In one aspect, virtual currency terminal(s) 111 obtain user information through use of a code (e.g. a QR code). In one aspect, virtual currency terminal(s) 111 is operable to present a code which a user scans using a user device in order to obtain user information. In one aspect, virtual currency terminal(s) 111 is operable to scan a code which a user presents via a user device in order to obtain user information. In one aspect virtual currency terminal(s) 111 is operable to provide a confirmation or other indicator upon successful completion of a virtual currency transaction.

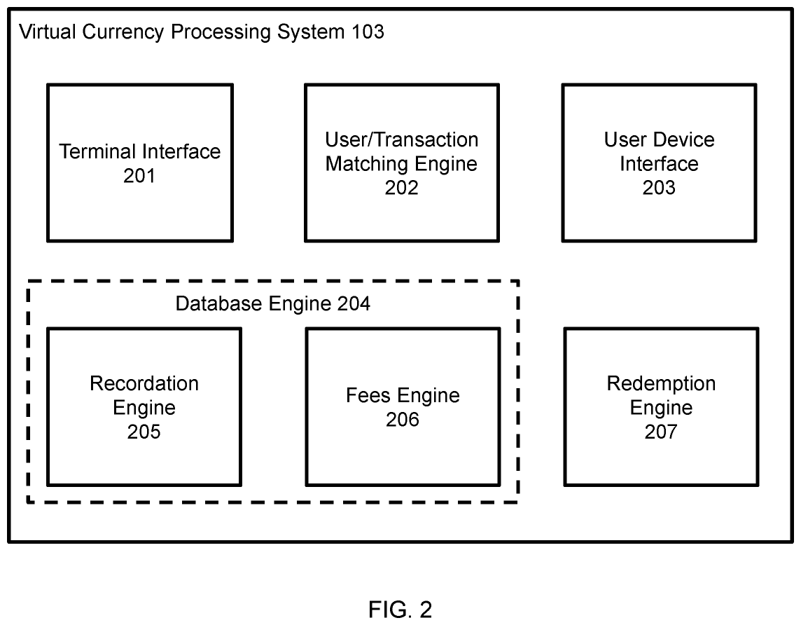

Virtual currency processing system 103 is operable to at least one of obtain transaction information, obtain user information, obtain merchant information, allocate virtual currency associated with transactions, maintain digital/electronic records of transaction and/or virtual currency information, and process fees associated with virtual currency transactions. In one aspect, during each transaction (or microtransaction) involving the virtual currency, there is no exchange of currency with a transaction, but instead, updates to electronic records (e.g. a digital ledger) as determined by virtual currency processing system 103. An actual exchange of currency may occur at periodic intervals such as daily, weekly, monthly and/or upon initiation of a process for settlement of funds/balances. In this way, rather than handling of coin change as part of the transaction process, users and merchants are able to rely on virtual currency conveniently managed electronically thereby reducing the need to carry coins in order to settle up transactions. More detailed operations of the virtual currency processing system 103 are discussed below with respect to FIG. 2.

Codes database 104 may comprise a plurality of codes (e.g. QR codes) for use in associating transaction information with at least one of user(s) and merchant(s) in order to ensure transaction information and associated virtual currency information is appropriately recorded. Codes database 104 may provide at least one code to at least one of user device(s) 110a and merchant device(s) 110b as part of processing a transaction involving virtual currency. In one aspect, for a given transaction each of the user device(s) and merchant device(s) associated with the transaction may be associated with the same code so that information relevant to the transaction can be matched as part of additional processing.

The system may optionally comprise virtual currency card 102 in addition to, or as an alternative to, user device(s) 110a for interaction with virtual currency terminal(s) 111. Virtual currency card 102 may be operable to at least one of obtain and provide user information and/or transaction information similar to that associated with user device(s) 110a. In one aspect, virtual currency card 102 may comprise at least one of a chip based card (e.g. contact based or RFID based), magnetic strip based, and the like.

User device(s) 110a generally comprise at least one computing device operable to at least one of provide and obtain information associated with virtual currency processing. User device(s) 110a include, generally, a computer or computing device including functionality for communicating (e.g., remotely) over a network 150. Data may be collected from user devices 110a, and data requests may be initiated from each user device 110a. User device(s) 110a may be a server, a desktop computer, a laptop computer, personal digital assistant (PDA), an in- or out-of-car navigation system, a smart phone or other cellular or mobile phone, or mobile gaming device, among other suitable computing devices. User devices 110a may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110a may be an electronic device including hardware, software, or embedded logic components or a combination of two or more such components and capable of carrying out the appropriate functions implemented or supported by the user device 110a. For example and without limitation, a user device 110a may be a desktop computer system, a notebook computer system, a netbook computer system, a handheld electronic device, or a mobile telephone. The present disclosure contemplates any user device 110a. A user device 110a may enable a network user at the user device 110a to access network 150. A user device 110a may enable its user to communicate with other users at other user devices 110a.

A user device 110a may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110a may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110a one or more Hyper Text Markup Language (HTML) files responsive to the HTTP request. The user device 110a may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110a may also include an application that is loaded onto the user device 110a. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### Virtual Currency Processing System

FIG. 2 illustrates an exemplary embodiment of the virtual currency processing system 103. The virtual currency processing system 103 comprises at least terminal interface 201, user/transaction matching engine 202, user device interface 203, database engine 204 which may be comprised of recordation engine 205 and fees engine 206, and redemption engine 207. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met. Although described herein with particular reference to coin change, the system is operable to apply the same fundamental concepts to any amount of change owed, including change involving whole dollar increments, and/or to handling partial amounts of change owed.

Terminal interface 201 is operable to communicate with at least one terminal such as those associated with merchant devices 110b of FIG. 1 (e.g. virtual currency terminal(s) 111 and POS terminal(s) 112). Terminal interface 201 may obtain at least one of transaction information, merchant information, and user information. Transaction information may comprise at least one of transaction timestamp (e.g. date, time, etc.), transaction amount (e.g. amount of coin change to be converted into virtual currency), and transaction code information (e.g. QR code). Merchant information may comprise at least one of merchant identifier (e.g. merchant name, location, etc.) and merchant device information associated with the transaction. User information may comprise at least one of user identifier and user device information.

User/transaction matching engine 202 is operable to associate obtained user information with at least one of transaction information and merchant information. In one aspect, associating comprises matching user information with at least one of transaction information and merchant information based on code information (e.g. QR code). For example, when a virtual currency terminal (e.g. terminal 111) is activated as part of a transaction, a code may be displayed on the terminal to be scanned by a user device such that user information can be matched with transaction information and/or merchant information. Upon a successful match the information can be provided to database engine 204 for appropriate recording and virtual currency allocation.

User device interface 203 is operable to obtain information from user device(s) such as user device(s) 110a. In one aspect, user device interface 203 is operable to obtain information from user devices in association with establishing and modifying user account information. User device interface may obtain at least one of user identification information, user bank account information, user preferences information, etc. In one aspect, user device interface 203 is operable to obtain request information from a user associated with redeeming or transferring of virtual currency funds.

Database engine 204 which may be comprised of recordation engine 205 and fees engine 206 is operable to maintain transaction records and/or handle fees associated with use of the virtual currency processing system 103. In one aspect, database engine 204 may be operable as a form of digital ledger for tracking the allocation of virtual currency and/or fees associated with users and/or merchants.

Fees engine 206 is operable to compute fees associated with virtual currency transactions. In one aspect, fees engine 206 computes at least one fee associated with each transaction. In one aspect, fees engine 206 provides an indication of any fee associated with the transaction for communication to other system components (e.g. to user device(s) and/or terminal(s) via their respective interfaces of the virtual currency processing system 103). In one aspect, fees may be flat fees (e.g. a per transaction fee) and/or percentage fees (e.g. a percentage of the virtual currency involved in the transaction). Other fee models may be used as would be apparent to one of ordinary skill in the art, such as recurring subscription fees (e.g. monthly), tiered fee structures depending on the number of transactions in a given time period (e.g. weekly, monthly, etc), etc.

Recordation engine 205 is operable to record at least one of terminal information, user device information, merchant device information, user information, merchant information, transaction information, matching information, virtual currency balance information, and fee information. Recordation engine 205 may, based on a match result obtained from matching engine 202, assign a corresponding amount of virtual currency to at least one of the user and merchant involved in the transaction. For example, in a scenario where a merchant owes an amount of coin change to a user, recordation engine 205 may allocate a credit of the amount owed to the user by associating or otherwise allocating the amount to the user account. Similarly, recordation engine 205 may allocate a debit of the amount owed to the user by associating or otherwise allocating the amount debited to the merchant account. In one aspect, the allocating comprises accounting for fees (as determined by fees engine 206) as part of the allocating so that fee information is accounted for as part of the allocating process. In this way, no actual currency exchange is occurring on a transactional basis, but instead a dynamic determination is made of user/merchant virtual currency balances. Over time certain parties involved in transactions (e.g. merchants) may accumulate substantial negative balances as a result of corresponding debits related to transactions. Invoices or other payment requests may be made at periodic intervals (e.g. monthly) or when the balance exceeds a threshold amount in order to settle the amount owed at which time an actual currency exchange would take place.

Redemption engine 207 is operable to allow accumulated virtual currency to be spent, redeemed, or otherwise used by at least one of a user and a merchant. In one aspect, redemption engine 207 is operable to allow a user to use accumulated virtual currency to pay for a transaction, such as by allocating virtual currency funds associated with a user (e.g. a user account) to virtual currency funds associated with a merchant (e.g. a merchant account). In one aspect, redemption engine 207 comprises allowing a user/merchant to redeem virtual currency for at least one of a gift card, a prepaid check/debit card, a check, and an electronic payment to the user/merchant (e.g. an ACH payment to a user's/merchant's bank account). In one aspect, redemption engine 207 is operable to provide virtual currency in the form of fungible and/or non-fungible tokens through communication with corresponding blockchain.

Processes for Managing Virtual Currency in Lieu of Coin Exchange in Association with Cash Transactions

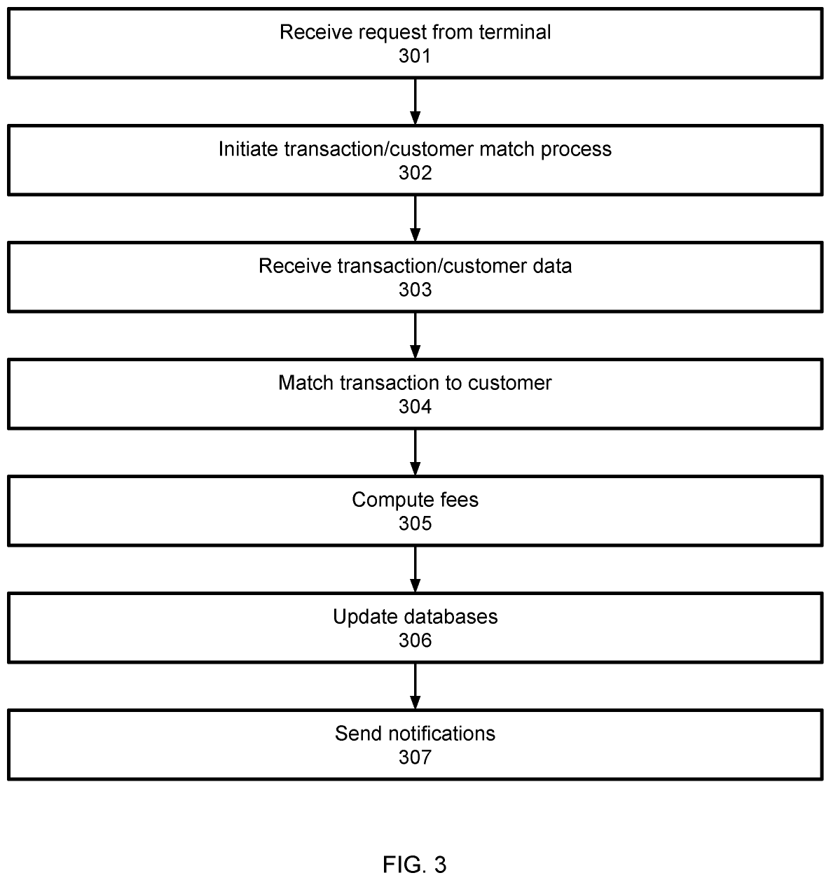

FIG. 3 illustrates an exemplary process for managing virtual currency in lieu of coin exchange in association with physical money transactions according to one embodiment of the invention. The process comprises receiving a request from a terminal 301, initiating a transaction/customer match process 302, obtaining transaction/customer data 303, matching a transaction to a customer 304, computing fees 305, updating databases 306, and sending notifications 307. The process may comprise additional steps, fewer steps, and/or a different order of steps without departing from the scope of the invention as would be apparent to one of ordinary skill in the art. Although described herein with particular reference to coin change, the fundamental aspects of the process may be applied to any amount of change owed, including change involving whole dollar increments, and/or to handling partial amounts of change owed.

At step 301, the process may comprise receiving a request from a virtual currency terminal (e.g. virtual currency terminal 111 or POS terminal 112 with incorporated virtual currency processing aspects). For example, upon activation of a terminal, the terminal sends a request to a server (e.g. virtual currency processing system 103) to initiate a virtual currency process, such as when a cash transaction is underway with a merchant and a user opts to receive coin change in the form of virtual currency instead of physical coin(s).

At step 302, the process may comprise initiating a process to match a transaction with a customer/user. In one aspect, this comprises generating or obtaining a transaction identifier. In one aspect, this comprises generating or obtaining a code (e.g. a QR code) to be used in associating the user, merchant and/or transaction information. The code may be provided to at least one of the terminal and user device (e.g. terminal 111 or 112, user device(s) 110a) such that user information, transaction information and merchant information may be associated with each other through use of the code.

At step 303, the process may comprise obtaining transaction and customer data. Transaction and customer data may comprise at least one of transaction information such as amount (e.g. amount of physical change to be converted to or allocated as virtual currency) and/or transaction identifier, merchant information (e.g. merchant paying or providing the virtual currency in lieu of physical coin change), user/customer information (e.g. user/customer to whom the virtual currency is to be allocated), and code data.

At step 304, the process may comprise matching the transaction data to customer data. In one aspect, the matching is based on matching a transaction identifier associated with a user and a merchant and/or transaction information. In one aspect, the matching is based on matching a code (e.g. a QR code) associated with a user and a merchant and/or transaction information. When a match is identified, the transaction data can be determined as valid and used to allocate virtual currency accordingly.

At step 305, the process may comprise computing fees associated with the transaction. In one aspect, each transaction is associated with a fee computed in real-time at the time of transaction so that the parties involved (e.g. users and/or merchants) can be notified of the associated fees and virtual currency allocation that will result as part of the transaction process. In one aspect, computing fees may comprise determining fees will be charged to only one party associated with the transaction. In one aspect, computing fees may comprises determining that no fees will be charged as part of an individual transaction (e.g. if a monthly subscription fee model is used as opposed to a per transaction fee model).

At step 306, the process may comprise updating databases to reflect the virtual currency transactions. In one aspect this comprises allocating a credit to an account associated with the party receiving virtual currency (e.g. a user/customer receiving virtual currency in lieu of physical monetary change for a purchase). In one aspect this comprises allocating a debit to an account associated with the party providing the virtual currency (e.g. a merchant providing virtual currency in lieu of physical monetary change for a purchase).

At step 307, the process may comprise providing notifications to parties involved in the transaction. In one aspect this comprises notifying at least one of a user/customer and a merchant of the associated amount of virtual currency to be credited/debited and the corresponding fees (if any) associated with the transaction. In one aspect, providing the notifications may comprise requiring at least one party involved in the transaction to acknowledge an/or approve of the notified virtual currency and/or fee amounts associated with the transaction.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

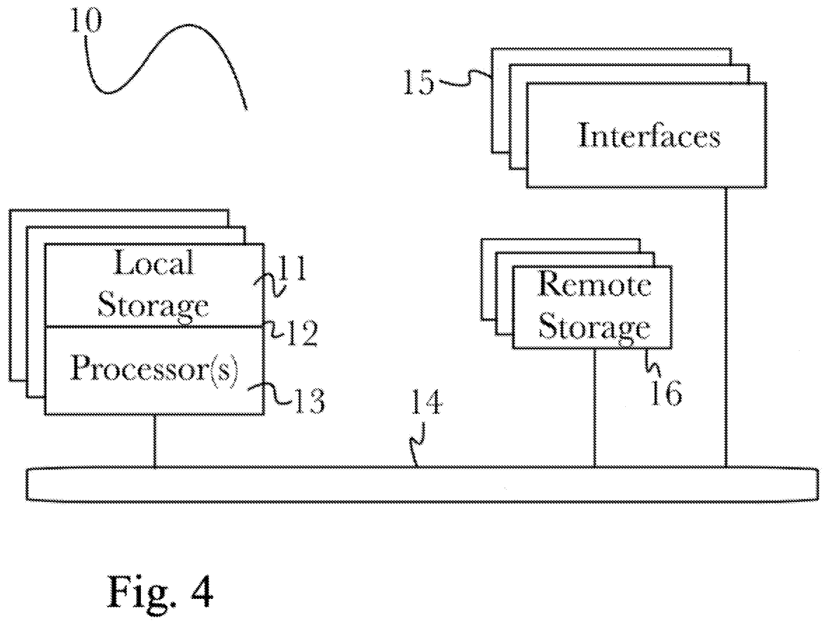

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, at least the virtual currency processing system 103, merchant device(s) 110b, user device(s) 110a, and subcomponents thereof may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

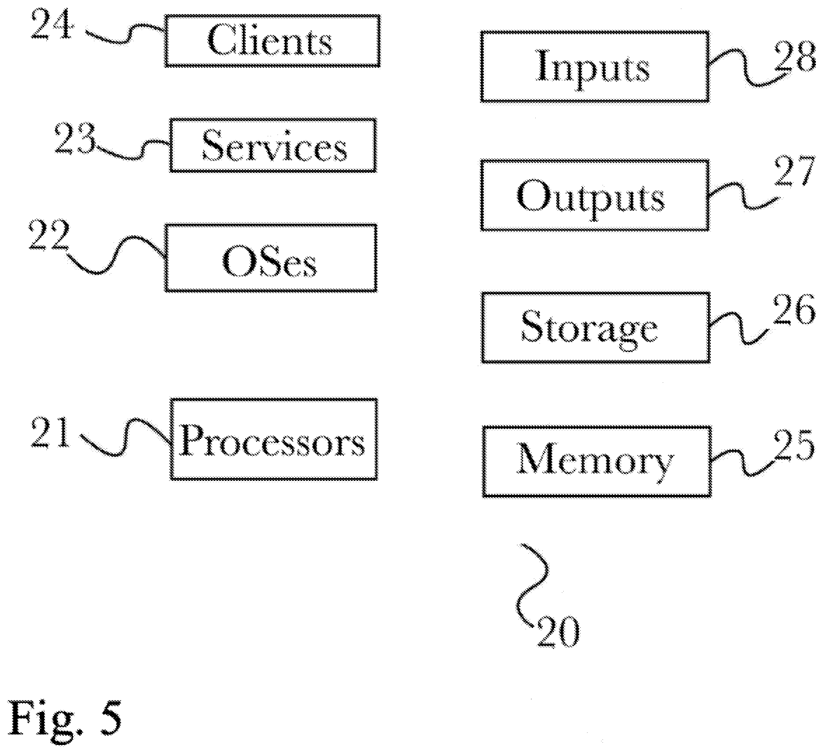

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

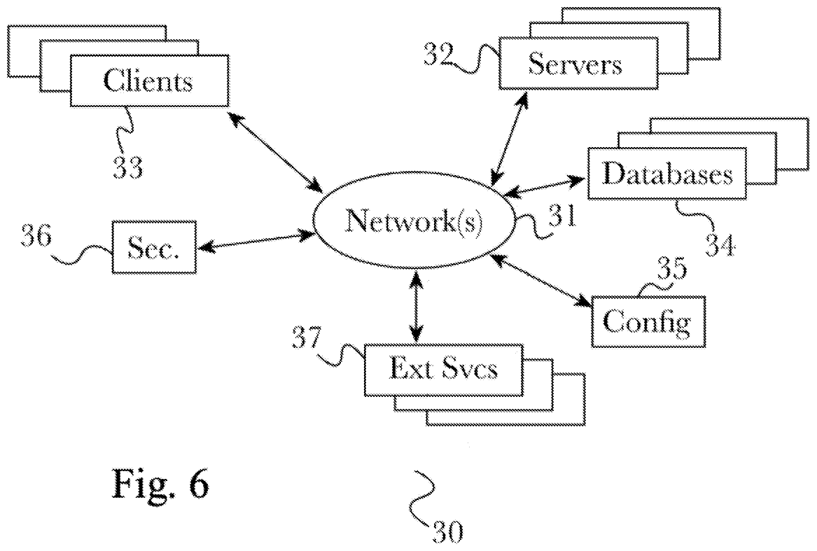

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

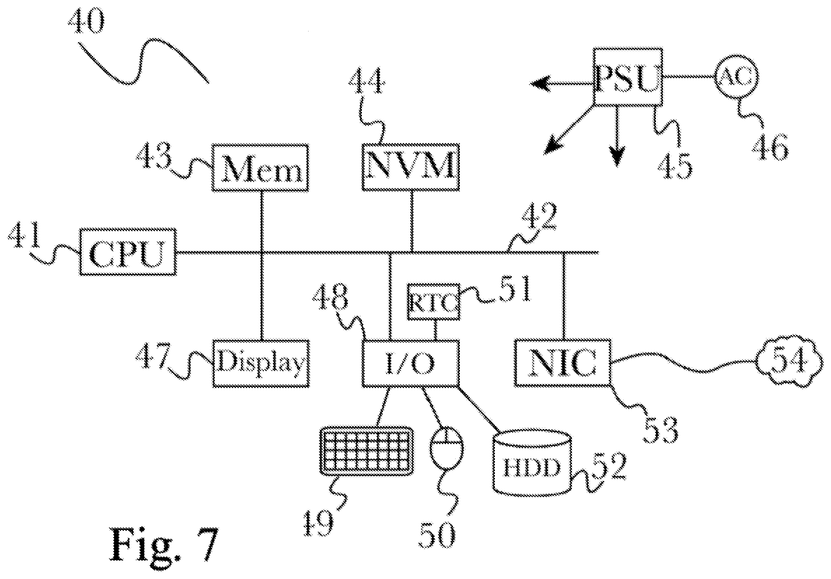

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer program product comprising a non-transitory computer readable storage medium having instructions encoded thereon that, when executed by a processor, enable the processor to:
obtain a request from a terminal in association with a transaction;
initiate a transaction-customer match process;
obtain transaction-customer data;
match a transaction to at least one of a customer and a merchant;
compute transaction fees;
update at least one of a transaction database, merchant database, and customer database; and
provide at least one notification to at least one of a customer and a merchant.
